(19) United States
(12) Patent Application Publication
(10) Pub. No.: US 2023/0277884 A1
(43) Pub. Date: Sep. 7, 2023

(54) SYSTEMS AND METHODS FOR EARLY CONTROLLED SPRINKLER ACTIVATION

(71) Applicant: JOHNSON CONTROLS TYCO IP HOLDINGS LLP, Milwaukee, WI (US)

(72) Inventors: Zachary L. Magnone, Warwick, RI (US); Pedriant Pena, Bellingham, MA (US)

(73) Assignee: Tyco Fire Products LP, Lansdale, PA (US)

(21) Appl. No.: 18/008,356

(22) PCT Filed: Jul. 8, 2021
(86) PCT No.: PCT/IB2021/056156

§ 371 Date: Dec. 5, 2022

Related U.S. Application Data
(60) Provisional application No. 63/049,709, filed on Jul. 9, 2020.

(51) Int. Cl. A62C 37/36; A62C 37/40; A62C 3/16; A62C 3/06

(52) U.S. Cl. CPC A62C 37/04; A62C 37/40; A62C 3/16; A62C 3/06

(57) ABSTRACT

A fire protection system includes at least one gas detector, at least one sprinkler, and one or more processors. The at least one gas detector detects a gas outputted by at least one energy storage device and outputs a detection signal responsive to detecting the gas. The at least one sprinkler outputs fluid on the at least one energy storage device responsive to be set to an open state. The one or more processors receive the detection signal, determine that a fire condition is present responsive to the detection signal, and control operation of the at least one sprinkler responsive to determining the fire condition to be present.

### CROSS-REFERENCE TO RELATED APPLICATIONS

The present application claims the benefit of and priority to U.S. Provisional Application No. 63/049,709, filed Jul. 9, 2020, the disclosure of which is incorporated herein by reference in its entirety.

### BACKGROUND

Fire suppression systems can use sprinklers to output fire suppression fluids to address a fire condition. For example, sprinklers can be triggered to output fluids responsive to detecting the fire condition.

### SUMMARY

At least one aspect relates to a fire protection system. The fire protection system can include at least one gas detector, at least one sprinkler, and one or more processors. The at least one gas detector can be positioned to detect a gas outputted by at least one energy storage device and output a detection signal responsive to detecting the gas. The at least one sprinkler can be positioned to output fluid on the at least one energy storage device. The one or more processors can receive the detection signal, determine that a fire condition is present responsive to the detection signal, and control operation of the at least one sprinkler responsive to determining the fire condition to be present.

At least one aspect relates to a method. The method can include detecting, by a gas detector, at least one of a concentration of a gas or a presence of the gas, determining, by one or more processors, a fire condition to be present responsive to the at least one of the concentration of the gas or the presence of the gas, identifying, by the one or more processors, at least one sprinkler associated with the gas detector responsive to determining the fire condition to be present, and triggering, by the one or more processors, operation of the identified at least one sprinkler responsive to identifying the at least one sprinkler.

At least one aspect relates to a fire control panel. The fire control panel can include one or more processors that receive, from at least one gas detector, a detection signal indicative of at least one of a presence of a gas outputted by an energy storage device or a concentration of the gas, determine that a fire condition is present responsive to the detection signal, identify at least one sprinkler based on the location of the at least one gas detector, and control operation of the identified at least one sprinkler responsive to determining the fire condition to be present.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a fire protection system.

FIG. 2 is a block diagram of an example of a controller of a fire protection system.

FIG. 3 is a flow diagram of an example of a method of operating a fire protection system.

FIG. 4 is a schematic diagram of an example of an electronically actuated sprinkler of a fire protection system.

### DETAILED DESCRIPTION

Following below are more detailed descriptions of various concepts related to, and implementations of sprinkler systems and methods. Fire sprinklers can be used to address fire conditions by outputting fire suppression agents, such as water or other fire suppression fluids, to address the fire. The fire sprinklers (or the fire suppression agent delivered to the fire sprinklers) can be controlled to selectively output fire suppression agents. The various concepts introduced above and discussed in greater detail below can be implemented in any of numerous ways, including in fire protection for energy storage systems.

Fire suppression systems can use electronically activated fire sprinklers (EASs). For example, the EAS can include an electronically actuatable mechanism that can change the sprinkler from a closed state to an open state responsive to a control signal. The control signal can be received from a fire control panel or other controller, which may generate and transmit the control signal responsive to a fire detection signal from a fire detector.

In some situations, fire conditions can be associated with thermal runaway events, in which the chemistry of the materials involved in the fire can exacerbate the fire condition. For example, components can release flammable gases (e.g., off gases, such as methane) that may reignite or explode even if oxygen removal is performed. Energy storage systems (ESSs), for example, can include large racks of battery modules, such as lithium ion battery modules, that may be installed in large rooms or containers analogous to shipping containers. The battery modules can have flammable electrolyte solutions and high levels of stored energy, such that battery failure can result in a cascading thermal runaway event. During thermal runaway, a self-perpetuating thermal reaction can occur, which can cause the battery modules to heat up and vaporize the flammable electrolyte solutions. The vapors can be vented and often ignited, which can result in large fires that are difficult to address. The resulting fire may be extinguished through the removal of oxygen, but because the reaction is self-sustaining the battery modules may continue to emit flammable vapors, which can lead to reignition and explosion. Letting the fire burn can mitigate the explosion hazard, but may produce large amounts of heat that can cause additional modules to become involved.

Systems and methods in accordance with the present solution can use fire detectors that detect gases to trigger operation of EASs to address fire conditions associated with the detected gases. This can enable a fire condition (or potential fire condition) of a battery module to be detected and addressed before fire ignition, and before a large amount of heat is generated that may be transferred from the battery module to other modules to an extent that may cause ignition of the other modules. The system can use water as the cooling agent to enable longer, continuous addressing of the fire condition. As such, the need for engineering controls such as modulation separation distances, cooling, and containment can be reduced, and the duration of thermal runaway events can be reduced. For example, a fire protection system can include at least one gas detector, at least one sprinkler, and one or more processors. The at least one gas detector can be positioned to detect a gas outputted by at least one energy storage device and output a detection signal responsive to detecting the gas. The at least one sprinkler can be positioned to output fluid on the at least one energy storage device. The one or more processors can receive the detection signal, determine that a fire condition is present responsive to the detection signal, and control operation of the at least one sprinkler responsive to determining the fire condition to be present. One or more components of the fire protection system can be implemented as a fire control panel. For example, the fire control panel can output a signal to control operation of the at least one sprinkler; the fire control panel can output a signal to the battery module(s) (or a battery management system that operates the battery modules) to shut off power or electrical connections with the battery modules.

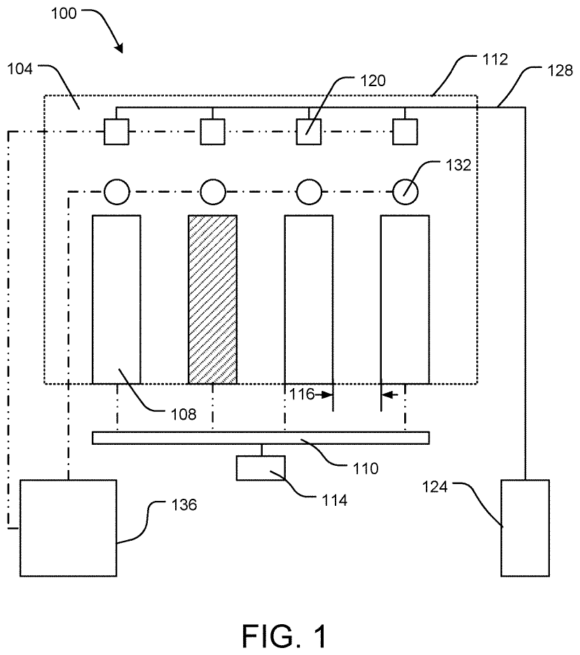

FIG. 1 depicts an example of a fire protection system 100. The fire protection system 100 can be implemented to address fire conditions in various buildings and spaces, including in storage spaces for components that may release flammable gases.

For example, the fire protection system 100 can be used for at least one energy storage module 104 (or various other components that may be susceptible to thermal runaway events.

The at least one energy storage module 104 can include at least one energy storage device 108 and an enclosure 112 that at least partially surrounds the at least one energy storage device 108. For example, as depicted in FIG. 1, the enclosure 112 can surround four energy storage devices 108. At least two adjacent energy storage devices 108 can be spaced by a spacing 116. Reducing the spacing 116 can increase the efficiency of space used by the energy storage devices 108, but can also allow for greater heat energy and off gases to be transferred between and around energy storage devices 108, including during a fire or a thermal runaway event.

The energy storage device 108 can be a battery module, such as a lithium ion battery module. The battery module can be relatively large and have a relatively high storage capacity, such as a capacity on the order of at least one kilowatt-hour (kWh). The energy storage device 108 can store energy received from a remote energy source (not shown), such as an electrical generator.

The energy storage device 108 can include or be coupled with a battery management system 110. The battery management system 110 can include an electronic controller (e.g., one or more processors) that manages storing of the energy received from the remote energy source. The battery management system 110 can monitor a state of each energy storage device 108. The battery management system 110 can selectively manage allocation of energy from the remote energy source to one or more of the energy storage devices 108, such as to perform load balancing.

At least one of the energy storage device 108 and the battery management system 110 can include or be coupled with at least one switch 114, through which energy can be received from the remote energy source or by which the energy storage devices 108 can be electrically connected with various components. As described further herein, the fire protection system 100 (e.g., a fire control panel implemented one or more components of the fire protection system 100) can at least one of control operation of the switch 114 to disconnect the at least one energy storage device 108 from the remote energy source (e.g., disconnect electrical connections to the energy storage devices 108) or transmit a signal (e.g., early alert or warning signal) to the battery management system 110 to enable the battery management system 110 to shut off power.

The energy storage device 108 can output gases, such as off gases such as methane. The energy storage device 108 may have electrolytes or other chemicals that can be flammable and can be susceptible to causing gases to be outputted. The outputted gases may be flammable. The energy storage device 108 can output gases at a first rate that is zero or less than a threshold while the energy storage device 108 is in a nominal operation condition, and at a second rate that is greater than the threshold while the energy storage device 108 is not in the nominal operating condition, such as if the energy storage device 108 is in a failure condition. The energy storage device 108 can output gases at a rate that can increase responsive to an increase in temperature of the energy storage device 108. The energy (e.g., chemical energy, electrical energy) stored by the energy storage device 108 may also act as potential energy that can be released during a fire or a thermal runaway event.

The fire protection system 100 can include a plurality of sprinklers 120. The sprinklers 120 can receive fluid from a fluid supply 124 from one or more pipes 128. The fluid supply 124 can be a water supply that can provide the water to the sprinklers 120. As described further herein, by using water from the fluid supply 124, the sprinklers 120 can output the water to cool the energy storage devices 108 over a longer period of time (e.g., as compared to gas-based fire suppression agents). The fluid supply 124 can include or be coupled with a source of firefighting agents such as wetting agents or class A foams, which can facilitate the water adhering to the surfaces to be cooled.

The sprinklers 120 can be positioned so that fluid outputted by the sprinklers 120 can contact the energy storage devices 108. For example, pipes 128 can extend from outside the enclosure 112 into the enclosure 112 so that the sprinklers 120 are positioned within the enclosure 112. The enclosure 112 may have an open top, such that the sprinklers 120 can be positioned above the enclosure 112 and the energy storage devices 108. The sprinklers 120 can be installed in various configurations, such as pendent or upright configurations.

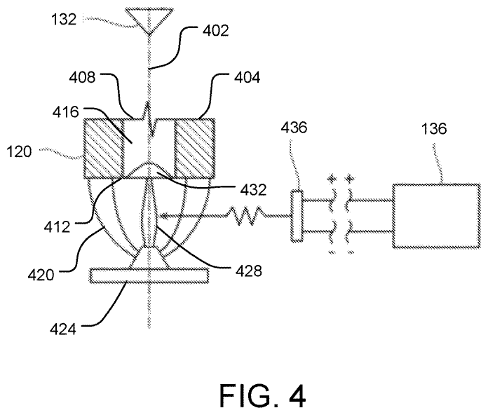

The sprinklers 120 can be EASs, which can enable the sprinklers 120 to be activated to output fluid and reduce the temperature of the energy storage devices 108 responsive to selected conditions, such as detection of gases, even if the temperature of the energy storage devices 108 or the air around the sprinklers 120 is less than a temperature indicative of a fire. Referring briefly to FIG. 4, the sprinkler 120 can include a body 404 that defines an inlet 408 and an outlet 412. The inlet 408 can be coupled with the one or more pipes 128 to receive the fluid from the one or more pipes 128 and output the fluid through the outlet 412. The sprinkler 120 can include one or more frame arms 420 that extend away from the outlet 412 relative to the inlet 408 to a deflector 424. The deflector 424 can include one or more tines or other structures that deflect the fluid received from the outlet 412 according to a target spray pattern. The sprinkler 120 can include a seal support 428, such as a frangible member (e.g., glass bulb), fusible link, hook and strut, or other component that maintains a seal 432 in the outlet 412 to prevent the fluid from flowing out of the outlet 412. The seal support 428 can extend between the outlet 412 and the seal 432 towards the deflector 424 (e.g., to where the deflector 424 meets the frame arms 420). The sprinkler 120 can include or be coupled with a solenoid valve (not shown) that controls flow through the outlet 412. The sprinkler 120 can include or be coupled with an actuator 436. The actuator 436 can cause the seal support 428 to change from a first state in which the seal support 428 maintains the seal 432 in the outlet 412 (e.g., applies sufficient force against the seal 432 in a direction towards the inlet 408 to prevent pressure from fluid between the inlet 408 and the outlet 412 from moving the seal 432 out of the outlet 412) to a second state in which the seal support 428 does not maintain the seal 432 in the outlet 412. For example, the actuator 436 can break the seal support 428 or move the seal support 428 away from axis 402, allowing the seal 432 to be displaced so that fluid can flow out of the outlet 412. The actuator 436 can be a linear actuator or rotary actuator. The actuator 436 can operate responsive to a control signal from the controller 136. The controller 136 can control operation of the solenoid valve (e.g., instead of using at least one of the seal support 428, the seal 432, and the actuator 436). The seal support 428 (e.g., glass bulb) can change from the first state to the second state responsive to a fire condition (e.g., threshold temperature, threshold rate of rise of temperature, threshold amount of heat); implementing the systems and methods described herein can enable the actuator 436 to cause the seal support 428 to change from the first state to the second state prior to the fire condition being present, enabling prevention of thermal runaway events.

Referring further to FIG. 1, the fire protection system 100 can include at least one gas detector 132. The gas detector 132 can detect gases outputted by the energy storage devices 108. The gas detector 132 can include various sensors, such as chemical or optical gas sensors. The gas detector 132 can output a detection signal that indicates at least one of a presence of a gas and an amount of the gas (e.g., concentration, such as parts per million (ppm)). For example, the gas detector 132 can output the detection signal to indicate the presence of the gas responsive to the concentration of the gas being greater than a threshold concentration (e.g., so that the detection signal itself indicates that the gas concentration is greater than the threshold concentration). The gas detector 132 can detect gases such as hydrogen, methane, carbon dioxide, or gases corresponding to organic- or electrolyte-based gases from the energy storage devices 108, such as diethyl carbonate. The gas detector 132 can generate the detection signal to include the indication of the at least one of the presence of the gas and the amount of the gas for one or more of the gases that the gas detector 132 is designed to detect. The fire protection system 100 can include a temperature sensor (not shown), which can provide temperature data, such as to confirm the fire condition.

As depicted in FIG. 1, the fire protection system 100 can include at least one sprinkler 120 and at least one gas detector 132 aligned with a corresponding energy storage device 108 (e.g., positioned vertically above), which can facilitate effective identification and actuation of the sprinklers 120. The sprinklers 120 can be supported on a rack above the energy storage devices 108. The gas detectors 132 can be closer to the energy storage devices 108 than the sprinklers 120. The fire protection system 100 can include various numbers of sprinklers 120 and detectors 132.

The fire protection system 100 can include at least one controller 136. The controller 136 can be implemented using a fire control panel. The controller 136 can be communicatively coupled with the sprinklers 120 and the gas detectors 132 (e.g., by wired or wireless connections). The controller 136 can receive the detection signals from the gas detectors 132. The controller 136 can generate control signals to cause operation of the sprinklers 120, such as to cause selected sprinklers 120 to switch from a closed state (in which the sprinklers 120 do not output fluid) to an open state (in which the sprinklers 120 can output fluid). The gas detector 132 output the detection signal at least one of periodically, in response to determining the concentration(s) of the one or more gases being greater than respective threshold concentration(s), or responsive to receiving a request for the detection signal from the controller 136.

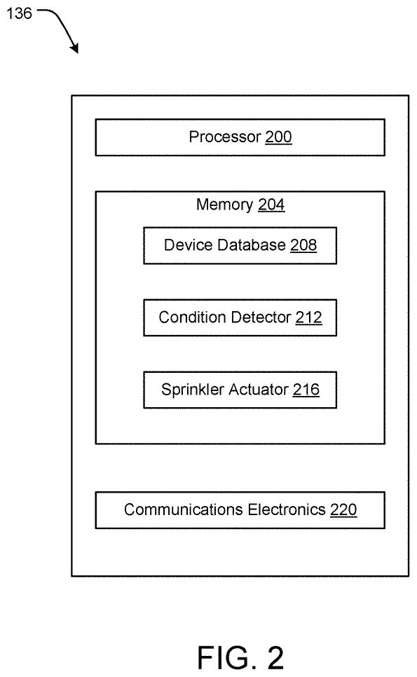

FIG. 2 depicts an example of the controller 136. The controller 136 can include at least one processor 200 and memory 204. The processor 200 may be implemented as a specific purpose processor, an application specific integrated circuit (ASIC), one or more field programmable gate arrays (FPGAs), a group of processing components, or other suitable electronic processing components. The memory 204 can include one or more devices (e.g., RAM, ROM, flash memory, hard disk storage) for storing data and computer code for completing and facilitating the various user or client processes, layers, and modules. The memory 204 can be or include volatile memory or non-volatile memory and may include database components, object code components, script components, or any other type of information structure for supporting the various activities and information structures of the inventive concepts disclosed herein. The memory 204 can be communicably connected to the processor 200 and include computer code or instruction modules for executing one or more processes described herein. The memory 204 can include various circuits, software engines, and/or modules that cause the processor 200 to execute the systems and methods described herein.

The controller 136 can include a device database 208. The device database 208 can include data entries corresponding to the sprinklers 120 and the gas detectors 132. For example, for a particular sprinkler 120, the device database 208 can include a data entry including an identifier of the particular sprinkler 120 and at least one identifier of at least one gas detector 132 associated with (e.g., mapped to) the particular sprinkler 120. The data entry can indicate one or more energy storage devices 108 associated with the particular sprinkler 120 (or the gas detector 132). The data entries can be generated responsive to user input (e.g., from a user interface implemented by the controller 136 or a remote device communicatively coupled with the controller 136), such as from setup and installation of the sprinklers 120 and gas detectors 132. The user input can indicate spatial relationships between the sprinklers 120, gas detectors 132, and energy storage devices 108, to facilitate identifying which sprinklers 120 to activate responsive to which gas detectors 132 detection signals are received from. For example, in a system as depicted in FIG. 1, the device database 208 can store data entries that indicate an association between each sprinkler 120 and the gas detector 132 that is below the sprinkler 120 (and can also indicate the energy storage device 108 below the sprinkler 120), as well as associations between at least one of adjacent sprinklers 120 and gas detectors 132 adjacent to sprinklers 120 (e.g., to indicate which sprinklers 120 are on either side of each other, as well as which sprinklers 120 are on either side of the gas detectors 132, to facilitate triggering operation of the sprinkler 120 that is above the gas detector 132 that detects the fire condition as well as one or more subsets of adjacent sprinklers 120). As the fire protection system 100 can be arranged with various numbers and locations of sprinklers 120 and gas detectors 132 relative to energy storage devices 108, various associations can be stored for the sprinklers 120 and gas detectors 132 based on their relative locations to link the sprinklers 120 and gas detectors 132 together in order to determine which sprinklers 120 to activate based on where fire conditions are detected. The device database 208 can maintain a map indicating locations of at least one of the energy storage devices 108, sprinklers 120, and gas detectors 132 to facilitate selectively identifying sprinklers 120 for activation based on location(s) at which fire conditions are detected. The device database 208 can assign one or more sprinklers 120 and one or more gas detectors 132 to a particular zone defined in the map, which can facilitate automatically activating each of the one or sprinklers 120 that are assigned to the particular zone responsive to determining that a fire condition is present in the particular zone.

The controller 136 can include a condition detector 212. The condition detector 212 can receive one or more detection signals from the gas detectors 132. The detection signals can include or indicate at least one of a gas concentration or a gas concentration relative to a threshold concentration (e.g., the detection signal can be triggered for transmission responsive to the gas detector 132 determining that the gas concentration is greater than threshold concentration). The condition detector 212 can associate the detection signal with the gas detector 132 from which the detection signal is received (e.g., based on extracting an identifier from the detection signal or associating a signal pathway from which the detection signal is received with the gas detector 132).

The condition detector 212 can be used to monitor for conditions such as fire conditions that may be indicated by the presence of the gases detected by the condition detector 212. For example, if the detection signal indicates the presence of the gas (e.g., the gas detector 132 from which the detection signal is received is calibrated to indicate the presence of the gas at a threshold indicative of a fire condition), the condition detector 212 can determine a condition (e.g., fire condition) to be present. If the detection signal indicates a concentration of the gas, the condition detector 212 can compare the concentration to the threshold concentration (which may be a specific concentration for the gas indicated by the detection signal), and determine the condition to be present responsive to the concentration being greater than the threshold concentration. The condition detector 212 can output a condition signal responsive to determining the condition to be present. The condition detector 212 can periodically transmit a request for the detection signal to one or more gas detectors 132 to receive the detection signal from the one or more gas detectors 132. The controller 136 can transmit a signal to at least one of the battery management system 110 and the switch 114 to cause disconnection of electrical connections with the at least one energy storage device 108 responsive to determining the condition to be present, which can facilitate early mitigation of conditions that may lead to thermal runaway events. The controller 136 can selectively cause disconnection of one or more particular energy storage devices 108 based on the positions of the energy storage devices 108 relative to the gas detectors 132 from which data was received that was used to determine that the condition is present.

The controller 136 can include a sprinkler actuator 216. The sprinkler actuator 216 can cause operation of one or more sprinklers 120 responsive to the condition being present. For example, the sprinkler actuator 216 can cause operation of the one or more sprinklers 120 responsive to the condition signal outputted by the condition detector 212. The sprinkler actuator 216 can cause operation of the sprinklers 120 by transmitting an actuation signal, such as to cause the actuator 436 depicted in FIG. 4 to change the sprinkler 120 to an open state (or cause a solenoid valve to open).

The sprinkler actuator 216 can selectively identify the one or more sprinklers 120 to cause operation of, such as by using location information and associations between sprinklers 120, gas detectors 132, and energy storage devices 108 stored by the device database 208. For example, the sprinkler actuator 216 can transmit the actuation signal to the sprinkler 120 (e.g., a first sprinkler 120) that is above (or closest to, or otherwise associated with in the device database 208) the energy storage device 108 that the gas detector 132 that outputted the detection signal used to determine that the condition is present is above (or closest to, or otherwise associated with in the device database 208). The sprinkler actuator 216 can operate in a zone-based mode by identifying one or more sprinklers 120 (e.g., second sprinklers 120) that are adjacent to the first sprinkler 120 and transmit the actuation signals to the second sprinklers 120. For example, sprinklers 120 can be assigned to zones in the device database 208. Operating the sprinklers 120 in the zone-based mode can enable more efficient water usage by more quickly controlling the fire condition.

For example, as depicted in FIG. 1, a fire condition is detected by the gas detector 132 that is associated with (e.g., as depicted, aligned with) the energy storage device 108 that is depicted with shading. For example, the gas detector 132 can monitor for one or more gases outputted by the energy storage device 108, and output a detection signal that indicates at least one of concentration(s) of the one or more gases or the presence(s) of the one or more gases. The condition detector 212 can receive the detection signal to detect that the condition is present responsive to the detection signal, such as to provide an indication that the condition is present to the sprinkler actuator 216. The sprinkler actuator 216 can use the device database 208 to identify one or more sprinklers 120 to activate responsive to the indication that the condition is present, such as to use the locations of the gas detectors 132 and the sprinklers 120 maintained by the device database 208 to identify at least the sprinkler 120 that is aligned with the gas detector 132 from which the detection signal was received. The sprinkler actuator 216 can transmit the actuation signal to the identify sprinkler 120 to cause operation of the sprinkler 120, such as to enable the sprinkler 120 to output a fluid (e.g., firefighting agent).

The sprinkler actuator 216 can operate with the sprinklers 120 and the gas detectors 132 in one or more modes. For example, responsive to determining the condition to be present based on receiving the detection signal from one of the gas detectors 132 (e.g., a first gas detector 132), the sprinkler actuator 216 can operate at least one gas detector 132 adjacent to the gas detector 132 from which the detection signal was received in an alert mode. In the alert mode, the gas detectors 132 can operate with at least one of greater sensitivity or greater responsiveness (e.g., relative to a non-alert mode of operation). For example, the gas detectors 132 (or sprinkler actuator 216) can determine the condition to be present responsive to the gas concentration being greater than a relatively lower threshold concentration; the gas detectors 132 can sample the gas concentration at a relatively greater sample rate; the sprinkler actuator 216 can more frequently request the detection signal from the gas detectors 132. The sprinkler actuator 216 can cause operation in the alert mode, initiate a timer responsive to causing operation in the alert mode, and cause operation in a non-alert mode (e.g., normal mode) responsive to the timer expiring (e.g., the timer increasing to be greater than a threshold duration of time, or the condition no longer detected to be present based on the detection signal from the first gas detector 132).

The controller 136 can include or be coupled with communications electronics 220. The communications electronics 220 can conduct wired and/or wireless communications. For example, the communications electronics 220 can include one or more wireless transceivers (e.g., a Wi-Fi transceiver, a Bluetooth transceiver, a NFC transceiver, a cellular transceiver). The controller 136 can use the communications electronics 220 to communicate with the gas detectors 132, the sprinklers 120, and remote devices, such as to provide status updates regarding the fire protection system 100 and the energy storage devices 108.

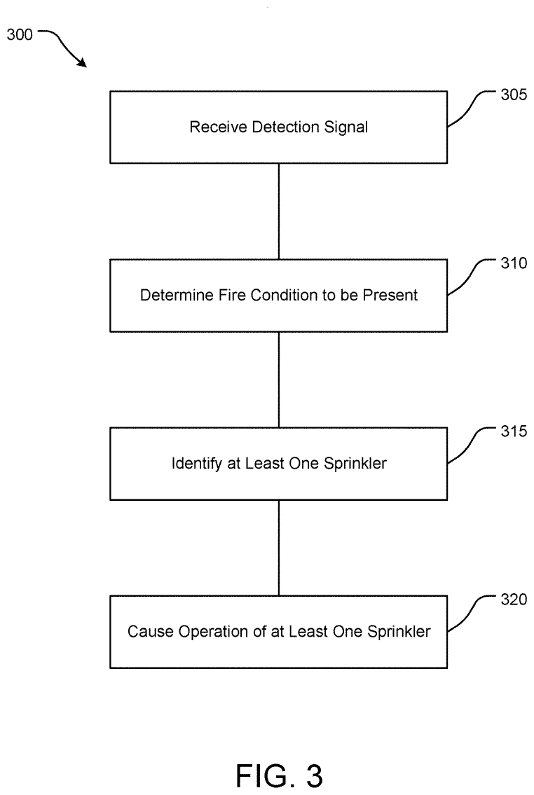

FIG. 3 depicts a method 300 of operating a fire protection system. The method 300 can be performed using various devices and systems described herein, such as the fire protection system 100. The method 300 can be performed to address fire conditions in various examples where it may be useful to detect the fire conditions based on signals other than temperature, such as gas concentrations, such as to protect energy storage systems.

At 305, a detection signal is received. The detection signal can be received from one or more gas detectors positioned around the space to be protected, such as around energy storage devices. The gas detector can generate the detection signal to indicate at least one of the presence of a gas and a concentration of the gas. The gas detector can generate the detection signal for a plurality of gases, such as off gases from an energy storage device. The gas detector can output the detection signal periodically, responsive to a request (e.g., a request transmitted from a controller), or responsive to determining that the concentration of the gas is greater than a threshold concentration.

At 310, a fire condition is determined to be present. The fire condition can be a condition in which a fire is present or likely to occur, such as due to off gases being outputted, or a likelihood of a thermal runaway event occurring. The fire condition can be determined to be present by the gas detectors, or by a remote device (e.g., controller) that receives the gas detection signal. The fire condition can be determined to be present responsive to the concentration of the gas being greater than the threshold concentration. The fire condition can be determined to be presented responsive to a rate of increase of the concentration of the gas being greater than a threshold rate of increase. The fire condition can be determined to be present based on evaluating gas concentrations of multiple gases (e.g., the concentration or rate of increase of concentration of each gas that the gas detector can detect can be assigned a weight, such that a weighted score can be compared to a respective threshold).

At 315, at least one sprinkler is identified. The sprinkler can be identified based on an identifier of the gas detector from which the detection signal is received. For example, a device database that maps associations between gas detectors and sprinklers (e.g., sprinklers that are positioned to output fluid on the energy storage devices that the gas detectors are positioned to detect off gassing from) can be used to identify at least one sprinkler that covers the energy storage device that outputted the gases detected by the gas detector. The at least one sprinkler can be identified from a zone that the gas detector (or a sprinkler associated with the gas detector) is assigned to. The at least one sprinkler can be identified to include the sprinkler closest to the gas detector and one or more adjacent sprinklers. The one or more adjacent sprinklers can be operated in an alert mode in which at least one of a concentration threshold for detecting the condition is decreased or rate of outputting of the gas concentration is increased.

At 320, the at least one sprinkler is caused to operate. For example, a control signal can be transmitted to switch the at least one sprinkler from a closed state in which the at least one sprinkler prevents fluid flow to an open state in which the at least one sprinkler outputs fluid. The control signal can be transmitted to a solenoid valve that selectively allows fluid flow through the sprinkler. The control signal can be transmitted to an actuator that causes a seal of the at least one sprinkler to be broken. The control signal can be transmitted simultaneously to each at least one sprinkler, or can be transmitted at a first time to the sprinkler closest to the gas detector and at a second time to the adjacent sprinkler(s).

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Computer program products are stored in a tangible form on non-transitory computer readable media and non-transitory physical hardware storage devices that are suitable for embodying computer program instructions and data. These include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory and other non-transitory devices.

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced. Other substitutions, modifications, changes, and omissions may be made in the design, operating conditions and arrangement of embodiments without departing from the scope of the present disclosure.

As utilized herein, the terms “approximately,” “about,” “substantially”, and similar terms are intended to include any given ranges or numbers +/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A fire protection system, comprising:
at least one gas detector positioned to detect a gas outputted by at least one energy storage device and output a detection signal responsive to detecting the gas;
a plurality of sprinklers positioned to output fluid on the at least one energy storage device; and
one or more processors that:
receive the detection signal;
determine that a fire condition is present responsive to the detection signal; and
identify at least one sprinkler of the plurality of sprinklers based on a location of the at least one gas detector from which the detection signal is received; and
control operation of the identified at least one sprinkler responsive to determining the fire condition to be present.

2. The fire protection system of claim 1, comprising:
the identified at least one sprinkler includes an electronically activated sprinkler.

3. The fire protection system of claim 1, comprising:
the at least one gas detector detects at least one of a presence of the gas and a concentration of the gas.

4. The fire protection system of claim 1, comprising:
the at least one gas detector outputs the detection signal responsive to determining that at least one of (i) a concentration of the gas is greater than a threshold concentration and (ii) a rate of increase of the concentration is greater than a threshold rate of increase.

5. The fire protection system of claim 1, comprising:
the one or more processors determine the fire condition to be present responsive to at least one of (i) a concentration of the gas is greater than a threshold concentration and (ii) a rate of increase of the concentration is greater than a threshold rate of increase.

6. (canceled)

7. The fire protection system of claim 1, comprising:
the at least one gas detector is a first gas detector;
the one or more processors, responsive to receiving the detection signal from the first gas detector, trigger an alert mode in which at least one of (i) the one or more processors increase a rate of requesting detection data from a second gas detector adjacent to the first gas detector and (ii) cause the second gas detector to increase a rate of outputting detection data.

8. The fire protection system of claim 1, comprising:
the one or more processors determine that the fire condition is present without using temperature data.

9. The fire protection system of claim 1, comprising:
an actuator that cause the identified at least one sprinkler to change to an open state responsive to a control signal transmitted by the one or more processors responsive to determining the fire condition to be present.

10. The fire protection system of claim 1, comprising:
the one or more processors transmit a signal to at least one of a switch coupled with the at least one energy storage device and a battery management system coupled with the at least one energy storage device to disconnect the at least one energy storage device.

11. A method, comprising:
detecting, by a gas detector, at least one of a concentration of a gas or a presence of the gas;
determining, by one or more processors, a fire condition to be present responsive to the at least one of the concentration of the gas or the presence of the gas;
identifying, by the one or more processors, at least one sprinkler associated with the gas detector from a plurality of sprinklers responsive to determining the fire condition to be present and based on a location of the gas detector; and
triggering, by the one or more processors, operation of the identified at least one sprinkler responsive to identifying the at least one sprinkler.

12. The method of claim 11, comprising:
outputting, by the gas detector, a detection signal responsive to determining that at least one of (i) a concentration of the gas is greater than a threshold concentration and (ii) a rate of increase of the concentration is greater than a threshold rate of increase.

13. The method of claim 11, comprising:
determining, by the one or more processors, the fire condition to be present responsive to at least one of (i) a concentration of the gas is greater than a threshold concentration and (ii) a rate of increase of the concentration is greater than a threshold rate of increase.

14. (canceled)

15. The method of claim 11, wherein the gas detector is a first gas detector, the method comprising:
triggering, by the one or more processors responsive to receiving a detection signal from the first gas detector, an alert mode in which at least one of (i) the one or more processors increase a rate of requesting detection data from a second gas detector adjacent to the first gas detector and (ii) cause the second gas detector to increase a rate of outputting detection data.

16. The method of claim 11, comprising:
causing, by the one or more processors, an actuator to change the identified at least one sprinkler to an open state responsive to determining the fire condition to be present.

17. A fire control panel, comprising:
one or more processors that:
receive, from at least one gas detector, a detection signal indicative of at least one of a presence of a gas outputted by an energy storage device or a concentration of the gas;
determine that a fire condition is present responsive to the detection signal;
identify at least one sprinkler from a plurality of sprinklers based on a location of the at least one gas detector; and
control operation of the identified at least one sprinkler responsive to determining the fire condition to be present.

18. The fire control panel of claim 17, comprising:
the one or more processors determine the fire condition to be present responsive to at least one of (i) a concentration of the gas is greater than a threshold concentration and (ii) a rate of increase of the concentration is greater than a threshold rate of increase.

19. The fire control panel of claim 17, comprising:
the one or more processors trigger, responsive to receiving the detection signal from the a first gas detector of the at least one gas detector, an alert mode in which at least one of (i) the one or more processors increase a rate of requesting detection data from a second gas detector of the at least one gas detector adjacent to the first gas detector and (ii) cause the second gas detector to increase a rate of outputting detection data.

20. The fire control panel of claim 17, comprising:
the one or more processors cause at least one of (i) an actuator to change the at least one sprinkler to an open state responsive to determining the fire condition to be present and (ii) at least one of a switch and a battery management system to disconnect an electrical connection of the energy storage device.

21. The fire protection system of claim 1, comprising:
the at least one gas detector comprises a plurality of gas detectors; and
the one or more processors are to:
receive the detection signal from a first gas detector of the plurality of gas detectors; and
responsive to the determination that the fire condition is present, at least one of (i) cause a second gas detector of the plurality of gas detectors adjacent to the first gas detector to increase a rate of detection of the gas and (ii) at least one of the first gas detector and the second gas detector decrease a threshold responsive to which detection data is outputted.

22. The fire protection system of claim 1, comprising:
the fluid includes at least one of a wetting agent and a foam.
